(19) United States
(12) Patent Application Publication
(10) Pub. No.: US 2025/0377802 A1
(43) Pub. Date: Dec. 11, 2025

(54) CLONING MODE

(71) Applicant: Micron Technology, Inc., Boise, ID (US)

(72) Inventor: Giuseppe Cariello, Boise, ID (US)

(21) Appl. No.: 19/226,893

(22) Filed: Jun. 3, 2025

Related U.S. Application Data
(60) Provisional application No. 63/658,555, filed on Jun. 11, 2024.

(51) Int. Cl. G06F 3/06

(52) U.S. Cl. CPC G06F 3/0613; G06F 3/0647; G06F 3/0673

(57) ABSTRACT

Methods, systems, and devices for supporting a cloning mode are described. A memory system may receive a first command associated with a cloning procedure for writing data to a set of memory cells of one or more memory devices, where the first command includes a first indication that indicates a set of addresses associated with the set of memory cells and a second indication that indicates a first write event or a second write event of at least two write events associated with the cloning procedure. The memory system may receive a first set of one or more first write commands to write the data to the set of memory cells, and the memory system may determine whether the first set of one or more first write commands correspond to the first write event or the second write event based on the second indication.

### CROSS REFERENCE

The present application for patent claims priority to U.S. Patent Application No. 63/658,555 by Cariello, entitled “CLONING MODE,” filed Jun. 11, 2024, which is assigned to the assignee hereof, and which is expressly incorporated by reference in its entirety herein.

### TECHNICAL FIELD

The following relates to one or more of host systems or memory systems, including a cloning mode for one or more of the host systems or the memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not- or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIGS. 1 and 2 show examples of systems that support implementing a cloning mode in accordance with examples as disclosed herein.

FIG. 3 shows an example of a process flow that supports implementing a cloning mode in accordance with examples as disclosed herein.

FIG. 4 shows a block diagram of a host system that supports implementing a cloning mode in accordance with examples as disclosed herein.

FIG. 5 shows a flowchart illustrating a method or methods that support a cloning mode in accordance with examples as disclosed herein.

### DETAILED DESCRIPTION

A device may perform a cloning procedure, which may involve transferring (e.g., writing, storing) data between locations in a memory system and/or between memory devices. For example, the device may replace the other device, and the data from the other device, such as user data, may be cloned to the device. In some cases, large quantities of data being transferred (e.g., written, stored) to the device may saturate (e.g., fill) one or more caches of the device, and may trigger garbage collection operations at the device. As such, operating the device during the cloning procedure may result in slower performance of the device (e.g., decreased processing, poor responsiveness) due to the one or more saturated caches and the garbage collection operations. Further, the data may be transferred (e.g., written) to the device including quad-level cells (QLCs) that may use a two-pass approach to writing data, which may additionally cause slower performance of the device for other operations. As such, techniques to improve device operation during a cloning procedure may be desired.

In accordance with examples as described herein, a memory system of a device may be configured to write data associated with a cloning procedure directly to QLC memory cells. For example, the memory system may operate in a cloning mode, which may enable data to be written to the QLC memory cells without first writing to tri-level cells (TLCs) or single level cells (SLCs), which may saturate one or more caches of the memory system. In some examples, a host system may output a command that indicates a set of memory addresses dedicated for the cloning procedure. Additionally, or alternatively, the command may indicate whether an upcoming set of write commands corresponds to a first write event (e.g., a first pass) or a second write event (e.g., a second pass) for writing the data to the QLC memory cells. As such, the data may be written directly to the QLC memory cells without writing to TLCs or SLCs, which may reduce a reliance on one or more caches of the memory system, thereby leaving the one or more caches free for other operations of the memory system and improving operation and response times of the device during the cloning procedure.

In addition to applicability in memory systems as described herein, techniques for implementing a cloning mode for a device may be generally implemented to support increased connectivity of electronic systems. As the use of systems relying on interconnected electronic devices increases, the connectivity of these electronic devices becomes an increasingly relevant factor for the operations of the system. For example, delays associated with signals communicated between devices may become increasingly relevant as critical systems come to rely more on connectivity, as a system uses larger quantities of interconnected devices, or if the quantity and the complexity of signals communicated between devices increases. Implementing the techniques described herein may support techniques for increased connectivity in electronic systems by improving the processing speed and user experience during cloning procedures, thereby allowing for the device to remain connected with other devices even during cloning procedures, among other benefits.

Features of the disclosure are illustrated and described in the context of systems, devices, and circuits. Features of the disclosure are further illustrated and described in the context of process flows and flowcharts.

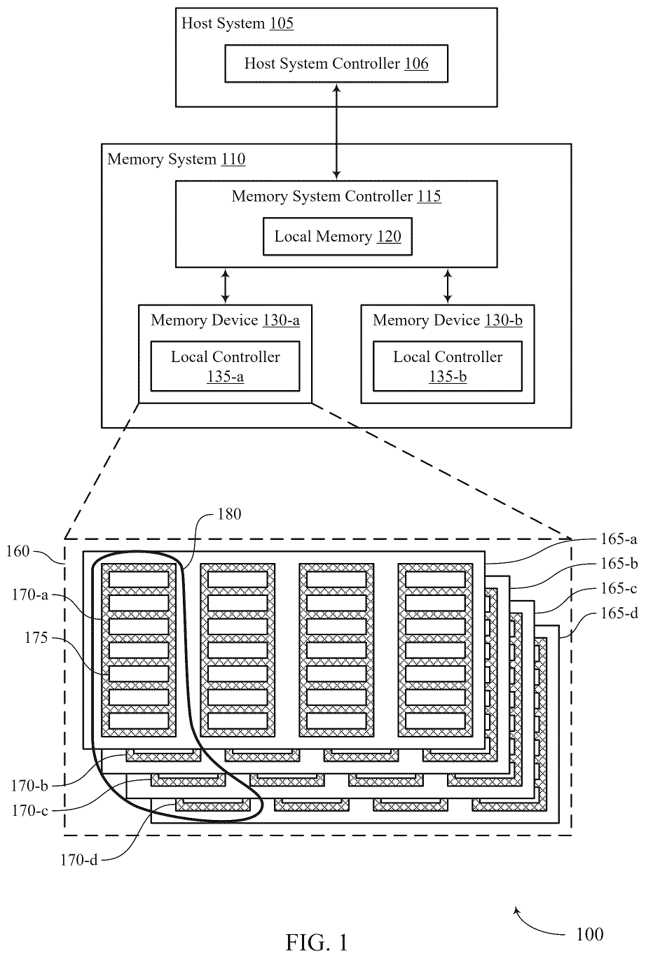

FIG. 1 shows an example of a system 100 that supports implementing a cloning mode in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as triple-level (e.g., or tri-level) cells (TLCs) if configured to each store three bits of information, as QLCs if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

The system 100 may include any quantity of non-transitory computer readable media that support a cloning mode. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some examples, the host system 105 may perform a cloning procedure, in which data may be written to the memory system 110. In some cases, the data may be written at the memory device 130-a, which may have one or more QLC memory cells. As the memory device 130-a may contain QLC memory cells which may involve two write events for writing the data to the QLC memory cells, the data may be temporarily written to a cache (e.g., the memory device 130-b, the local memory 120) of the memory system 110. The cache may have insufficient capacity to contain the data associated with the cloning procedure, for example, due large quantities of data (e.g., equal to greater than a threshold), however, and garbage collection operations may be triggered at the memory system 110 (e.g., by the memory system controller 115). As such, operating the memory system 110 during the cloning procedure may result in slower performance (e.g., processing of other operations, actions, or tasks) and poor responsiveness due to the saturated caches and the garbage collection operations.

In accordance with examples as described herein, the memory system 110 may be configured to write data associated with a cloning procedure directly to QLC memory cells of the memory device 130-a. For example, the memory system 110 may operate in a cloning mode, which may enable data to be written to the QLC memory cells while reducing saturation at one or more caches (e.g., a TLC cache and/or an SLC cache) of the memory system 110 during the cloning procedure. In some examples, the host system 105 may output a command that indicates a set of memory addresses associate with the memory system 110 (e.g., with one or more memory devices 130-a of the memory system 110) dedicated for the cloning procedure. Additionally, or alternatively, the command may indicate whether an upcoming set of write commands corresponds to a first write event (e.g., a first pass) or a second write event (e.g., a second pass) for writing the data to the QLC memory cells. As such, the data may be written directly to QLC memory cells of the memory device 130-a without first writing to TLC memory cells and/or SLC memory cells, which reduces a reliance on one or more caches of the memory system 110 associated with TLC and SLC, thereby maintaining (e.g., preserving) the one or more caches free for other operations of the memory system 110, and improving operation and response times during the cloning procedure.

The system 100 may include any quantity of non-transitory computer readable media that support a cloning mode. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

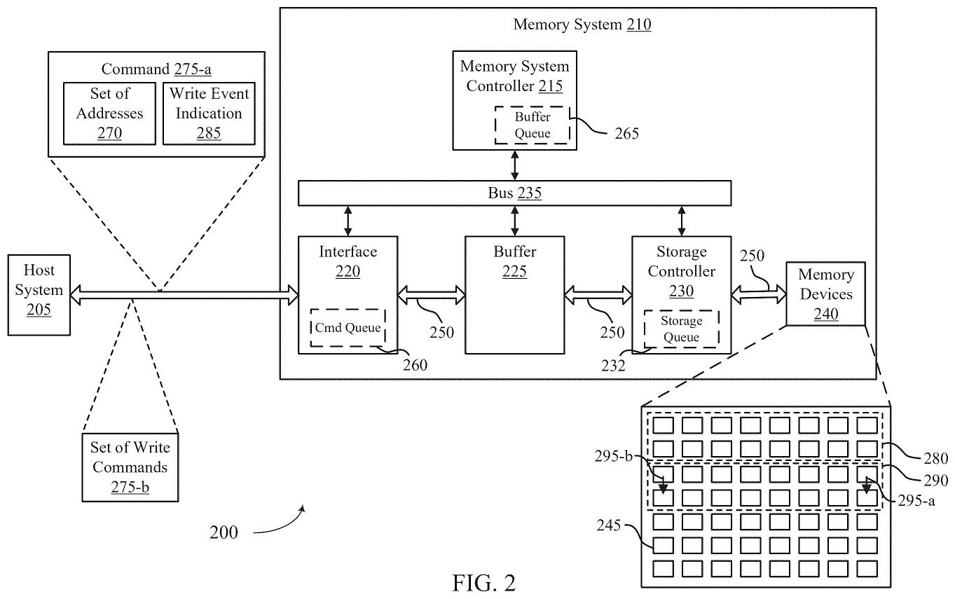

FIG. 2 shows an example of a system 200 that supports implementing a cloning mode in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). For example, the memory system 210 may be configured to store data associated with a cloning procedure at one or more memory cells (e.g., QLCs) of the one or more memory devices 240.

The memory system 210 may include a storage controller 230 for controlling the passing of data directly to and from the memory devices 240 (e.g., for storing data, for retrieving data, for determining memory locations in which to store data and from which to retrieve data). In some cases, a storage controller 230 may implement aspects of a local controller 135 as described with reference to FIG. 1. The memory system 210 may include an interface 220 for communication with the host system 205, which may include a vendor-specific interface. The memory system 210 may also include a buffer 225 (e.g., an SRAM buffer, a cache) for temporary storage of data being transferred between the host system 205 and the memory devices 240. For example, the buffer 225 may allow data to be buffered while commands are being processed, reducing latency between commands and supporting arbitrary data sizes associated with commands. The interface 220, buffer 225, and storage controller 230 may support translating data between the host system 205 and the memory devices 240 (e.g., as shown by a data path 250), and may be collectively referred to as data path components.

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between components of the memory system 210. In some cases, one or more queues (e.g., a command queue 260, a buffer queue 265, a storage queue 232) may be used to control the processing of access commands and the movement of corresponding data. This may be beneficial, for example, if more than one access command from the host system 205 is processed concurrently by the memory system 210. The command queue 260, buffer queue 265, and storage queue 232 are depicted at the interface 220, memory system controller 215, and storage controller 230, respectively, as examples of a possible implementation. However, queues, if implemented, may be positioned anywhere within the memory system 210.

The memory devices 240 may include multiple memory blocks 245 for storage of data, and each memory block 245 may refer to one or more memory cells (e.g., which may have sequential logical addresses, and sequential or non-sequential physical addresses). For example, the memory devices may include one or more memory blocks 245 operated as QLC memory cells, which may be used to store data. In some examples, the memory devices 240 may designate a set of memory blocks as a cache 280, which may include one or more memory cells that may be operated as SLC memory cells, TLC memory cells, or as MLC memory cells. In some examples, the memory blocks 245 dynamically allocated as QLC memory cells or as part of the cache 280, such that memory blocks 245 may be reused as different memory cell types for different purposes. The memory blocks of the cache 280 may be used to store data for faster access by the memory system 210, in addition to storing the data at memory blocks 245 operated as QLC memory cells. For example, SLC memory cells or TLC memory cells of the cache 280 may be associated with relatively faster access speeds than QLC memory cells. As such, if the host system 205 requests data that has been stored at the cache 280, the memory system 210 may output the data with a relatively lower latency than if the data was stored only at QLC memory cells of the memory devices 240.

In some cases, however, the cloning procedure may be associated with writing large quantities of data to the one or more memory devices 240. As such, during the cloning procedure, the SLC memory cells and/or the TLC memory cells of the cache 280 may be taken up by the data (e.g., may become exhausted), and garbage collection operations may be triggered at the memory system 210 (e.g., by the memory system controller 215). As such, operating the memory system 210 while the cloning procedure is being performed may result in slower performance (e.g., processing speed) and responsiveness due to the garbage collection operations needed to free up the cache 280. For example, the SLC memory cells and the TLC memory cells of the cache 280 may be dimensioned to absorb (e.g., store) a typical daily operating load (e.g., 30-50 gigabytes, for example), and the cache 280 may be unavailable for other traffic of the memory system 210, thereby resulting in slower performance as the memory system 210 relies on other memory cells of the cache 280.

In accordance with examples as described herein, the host system 205 may output a command 275-a which may support (e.g., assist) the memory system 210 in identifying data (e.g., write traffic) associated with a cloning procedure. For example, the command 275-a may include a set of addresses 270 (e.g., memory addresses, logical memory addresses) of the memory system 210 (e.g., of the one or more memory devices 240), which may indicate a range of memory addresses (e.g., logical block addresses) dedicated for the cloning procedure (e.g., one or more cloning procedures). Additionally, or alternatively, the command 275-a may include a write event indication 285, which may indicate to the memory system 210 whether an upcoming (e.g., future, pending) set of write commands 275-b associated with the cloning procedure corresponds to a first write event or a second write event (e.g., for QLCs at the one or more memory devices 240). In some examples, the command 275-a may be a vendor unique command, which may be issued via a vendor unique interface (e.g., the interface 220, or another interface between the host system 205 and the memory system 210).

For example, the memory system 210 may receive the set of write commands 275-b. The memory system 210 may determine that the set of write commands 275-b correspond to the cloning procedure based on the specified address (e.g., logical address, of or indicated by the set of addresses 270), and the memory system 210 may write the data directly to the one or more memory addresses 290. For example, the memory system 210 may write the data at a memory block 245 of the set of memory blocks 245 configured in QLCs mode corresponding to an address of the one or more memory addresses 290.

Additionally, or alternatively, to indicate that the data corresponds to the cloning procedure, the command 275-a, the set of write commands 275-b, or both, may include an indication of a context identifier (e.g., a context ID). For example, a context group may be defined to classify commands associated with a cloning procedure. The command 275-a, the set of write commands 275-b, or both, may include an indication of a context identifier corresponding to the context group for the cloning procedure. As such, the memory system 210 may identify that the data indicated by the set of write commands 275-b corresponds to data for a cloning procedure and may initiate the cloning mode.

In some examples, after receiving the set of write commands 275-b, the memory system 210 may determine whether the set of write commands 275-b corresponds to a first write event or a second write event for writing the data at the one or more memory devices (e.g., at the QLCs). For example, the memory system 210 may determine that the set of write commands 275-b corresponds to the first write event (e.g., a first pass) based on the write event indication 285 included in the command 275-a. Additionally, or alternatively, the memory system 210 (e.g., via the interface 220) may determine a value of a flag (e.g., a flag bit) that indicates whether the one or more locations 295 have been previously written (e.g., for the same cloning procedure), or the memory system (e.g., via the interface 220) may check (e.g., evaluate, analyze, validate, verify) a logical-to-physical mapping (e.g., table) to determine whether the set of write commands 275-b correspond to the first write event or the second write event.

The memory system 210 may write the data at the one or more memory devices 240 in accordance with the first write event or the second write event. For example, if the memory system 210 determines that the set of write commands 275-b corresponds to the first write event, the memory system 210 may write the data at location 295-a corresponding to a first cursor associated with the first write event. Additionally, or alternatively, writing procedures for the one or more memory devices 240 may vary based on whether the writing is performed as the first write event or for the second write event. The memory system 210 may update the location 295-a corresponding to the first cursor in response to writing the data, while a second cursor corresponding to a second location 295-b associated with the second write event may be left (e.g., remain, maintained) unchanged as shown in FIG. 2. In some examples, after writing the data at the one or more memory devices 240 and completion of the first write event, the memory system 210 may update the value of the flag (e.g., one or more flags) to indicate that the first write event has been completed at one or more locations 295.

The memory system 210 may receive an additional set of write commands indicating the data to write at the one or more location beginning at the location 295-b corresponding to the second cursor associated with the second write event. The memory system 210 may determine that the additional set of write command corresponds to the second write event based on a second command including a second write event indication 285, based on a context identifier included within the additional set of write commands, based on the value of the flag, or any combination thereof. The memory system 210 may then write the data at the one or more locations beginning at the location 295-b of the one or more memory devices 240 in accordance with the second write event.

In some cases, the memory system 210 may be configured with a threshold quantity of locations 295 to be written between the first write event and the second write event. For example, a distance between the first write event and the second write event (e.g., in terms of memory locations 295) may be fixed (e.g., set, constant), which may reduce write disturb that may be caused by rapidly performing the first write event and the second write event at a same location 295. In some examples, the threshold quantity of locations 295 written between the first write event and the second write event may be suspended while the memory system 210 operates in the cloning mode (e.g., performs the cloning procedure). For example, the memory system 210 may write a quantity of locations 295 between the first write event and the second write event that exceeds the threshold quantity of locations 295. For instance, the memory system 210 may perform the first write event for the entire data associated with the cloning procedure prior to performing the second write event for any portion of the data associated with the cloning procedure. Additionally, or alternatively, the memory system 210 may include an exception mechanism which may signal to the host system 205 to switch between the first write event (e.g., a first pass) and the second write event (e.g., a second pass), and issue corresponding write commands, which may allow the memory system 210 to exceed the threshold quantity of locations 295 to be written between the first write event and the second write event.

In some cases, randomizing the order of data written during the second write event may result in additional disturbance for one or more location 295. For example, a page of the memory device 240 may receive coupling disturbances from both sides due to the random order, which may cause unreliable behavior for the page. As such, it may be beneficial to perform the second write event in a same order as the first write event. For example, the memory system 210 (e.g., via the storage controller 230) may track a position of the second cursor corresponding to the location 295-b during the second write event. If the memory system 210 determines that the order of the data written during the second write event is different than the order of the data written during the first write event, the memory system 210 may output an error (e.g., to the host system 205).

In some examples, the memory system 210 may perform defragmentation on the data indicated by the set of write commands 275-b while performing the first write event (e.g., during the first write event). As logic for determining the order of the data to be written during the second write event may be the same as logic for the order of the first write event, the second write event may be written in the same order as the first write event even when defragmentation is performed.

Accordingly, the memory system 210 may write the data associated with the cloning procedure directly at the one or more memory devices 240, and the memory system 210 may refrain from writing the data at SLC memory cells or TLC memory cells of the buffer 225. Thus, the SLC memory cells and TLC memory cells may be available for other operations of the memory system 210 during the cloning procedure, thereby improving processing speeds for the memory system 210.

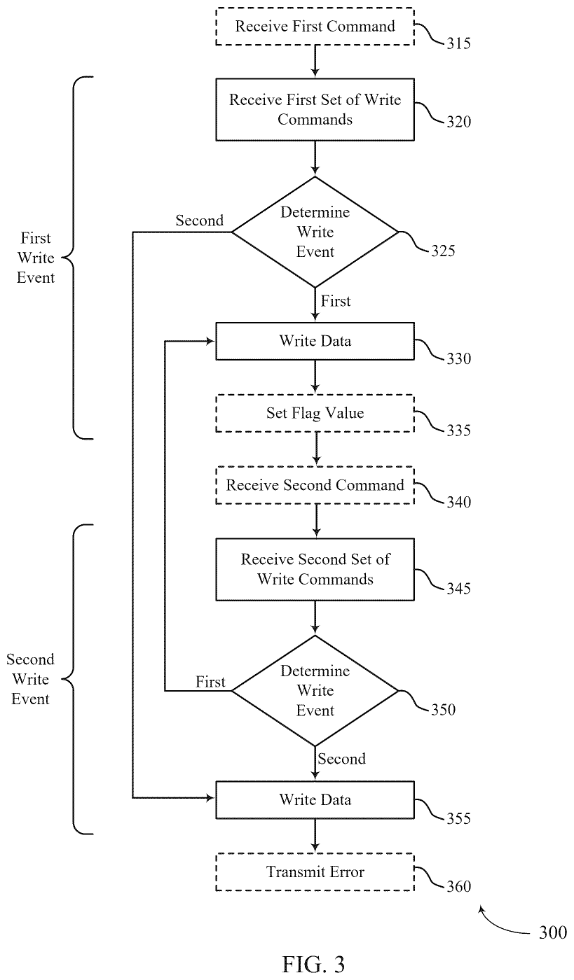

FIG. 3 shows an example of a process flow 300 that supports implementing a cloning mode in accordance with examples as disclosed herein. The process flow 300 illustrates processes performed by a memory system and signaling exchanged between a host system and the memory system, which may be examples of corresponding devices as described herein, with reference to FIGS. 1 and 2. Some operations may also be omitted from the process flow 300, and other operations may be added to the process flow 300.

At 315, the host system may issue a first command associated with a cloning procedure for writing data to a set of memory cells (e.g., QLCs) of the memory system. The memory system may receive the first command. In some examples, the first command may include a first indication that indicates a set of addresses associated with the set of memory cells dedicated for the cloning procedure. Additionally, or alternatively, the command may include a second indication that indicates a first write event or a second write event of at least two write events associated with the cloning procedure. In some examples, the first command may include a context identifier (e.g., context ID) that corresponds to a context group associated with the cloning procedure.

Operations 320 through 335 may correspond to operations for the first write event. For example, at 320, the memory system may receive a first set of one or more write commands to write the data to the set of memory cells. In some examples, the set of one or more write commands may include a context identifier that corresponds to the context group associated with cloning procedures.

At 325, the memory system may determine whether the first set of one or more first write commands correspond to the first write event or the second write event of the at least two write events associated with the cloning procedure based on the second indication. For example, the memory system may determine that the first set of one or more first write commands correspond to the first write event based on the second indication. If the first set of one or more write commands correspond to the first write event, the process moves to 330. If the first set of one or more write commands correspond to the second write event, the process moves to 355.

At 330, the memory system may write the data to the set of memory cells associated with the set of addresses in accordance with the first write event or the second write event of the at least two write events based on determining whether the first set of one or more first write commands correspond to the first write event or the second write event. For example, the memory system may write the data in accordance with the first write event (e.g., beginning at a memory location indicated by a first cursor associated with the first write event, following write procedures corresponding to the first write event). In some examples, the memory system may refrain from writing the data to at least one cache, which may include one or more SLCs or TLCs.

At 335, after completion of the first write event, the memory system may update a value of a flag to indicate that the first write event has been completed. In some examples, the flag may be associated with the range of logical block addresses designated for the cloning procedure. In some examples, one or more operations corresponding to the first write event (e.g., one or more of operations 320 through 335) may be repeated multiple times (e.g., iteratively executed) to complete the first write event.

At 340, the host system may issue a second command associated with the cloning procedure. The memory system may receive the second command. The second command may include a third indication that indicates the set of addresses. Additionally, or alternatively, the host system may include a fourth indication that indicates that a second set of one or more second write commands for writing the data corresponds to the second write event of the at least two write events.

Operations 345 through 355 may correspond to operations for the second write event. For example, at 345, the memory system may receive the second set of one or more second write commands to write the data to the set of memory cells. In some examples, the second set of one or more second write commands may include a context identifier corresponding to the context group associated with the cloning procedure.

At 350, the memory system may determine that the second set of one or more second write commands corresponds to the second write event. For example, the memory system may determine that the second set of one or more second write commands corresponds to the second write event based at least in part on the fourth indication, on the value of the flag, or both. If the second set of one or more write commands correspond to the first write event, the process moves to 330. If the first set of one or more write commands correspond to the second write event, the process moves to 355.

At 355, the memory system may write the data to the set of memory cells associated with the set of addresses in accordance with the second write event. For example, the memory system may write the data starting at a second cursor corresponding to the second write event. In some examples, while performing the second write event, the memory system may track (e.g., monitor) a position of the second cursor. In some examples, if the memory system determines that the order of the data written during the second write event differs from an order of the data as written during the first write event, at 360, the memory system may output an indication of an error (e.g., an exception). The indication of the error may indicate that the second write event was written out of order, and may indicate to the host system to re-attempt the second write event, or the entire cloning procedure. Additionally, or alternatively, an indication of an error may be outputted by the memory system before or after other operations of the process flow 300, for example, due to an error detected by the memory system.

In some examples, one or more operations corresponding to the second write event (e.g., one or more of operations 320 through 335) may be repeated multiple times (e.g., iteratively executed) to complete the second write event. Similarly, in some examples, one or more operations 315 through 355 may be repeated multiple times (e.g., iteratively executed) to complete the cloning procedure.

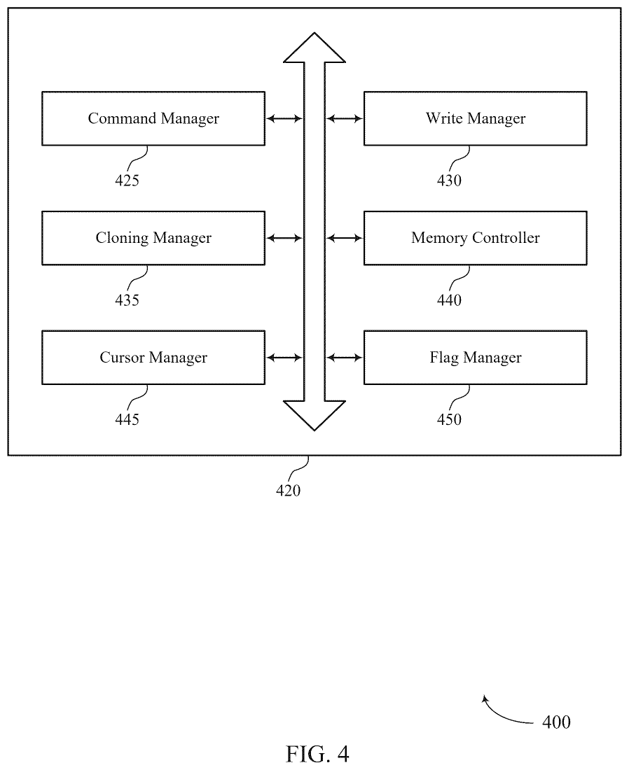

FIG. 4 shows a block diagram 400 of a memory system 420 that supports implementing a cloning mode in accordance with examples as disclosed herein. The memory system 420 may be an example of aspects of a memory system as described with reference to FIGS. 1 through 3. The memory system 420, or various components thereof, may be an example of means for performing various aspects of cloning mode as described herein. For example, the memory system 420 may include a command manager 425, a write manager 430, a cloning manager 435, a memory controller 440, a cursor manager 445, a flag manager 450, or any combination thereof. Each of these components, or components of subcomponents thereof (e.g., one or more processors, one or more memories), may communicate, directly or indirectly, with one another (e.g., via one or more buses).

The command manager 425 may be configured as or otherwise support a means for receiving a first command associated with a cloning procedure for writing data to a set of memory cells, where the first command includes a first indication that indicates a set of addresses associated with the set of memory cells and a second indication that indicates a first write event or a second write event of at least two write events associated with the cloning procedure. The write manager 430 may be configured as or otherwise support a means for receiving a first set of one or more first write commands to write the data to the set of memory cells. The cloning manager 435 may be configured as or otherwise support a means for determining whether the first set of one or more first write commands correspond to the first write event or the second write event of the at least two write events associated with the cloning procedure in response to the second indication. The memory controller 440 may be configured as or otherwise support a means for writing the data to the set of memory cells associated with the set of addresses in accordance with the first write event or the second write event of the at least two write events in response to the determining.

In some examples, the first set of one or more first write commands corresponds to the first write event, and the command manager 425 may be configured as or otherwise support a means for receiving a second command associated with the cloning procedure, where the second command includes a third indication that indicates the set of addresses and a fourth indication that indicates that a second set of one or more second write commands for writing the data corresponds to the second write event of the at least two write events. In some examples, the first set of one or more first write commands corresponds to the first write event, and the write manager 430 may be configured as or otherwise support a means for receiving the second set of one or more second write commands to write the data to the set of memory cells. In some examples, the first set of one or more first write commands corresponds to the first write event, and the cloning manager 435 may be configured as or otherwise support a means for determining that the second set of one or more second write commands corresponds to the second write event in response to the fourth indication. In some examples, the first set of one or more first write commands corresponds to the first write event, and the memory controller 440 may be configured as or otherwise support a means for writing the data to the set of memory cells associated with the set of addresses in accordance with the second write event.

In some examples, the write manager 430 may be configured as or otherwise support a means for identifying a set of logical block addresses in response to one or more of the first indication or the second indication, where the set of logical block addresses correspond to the set of addresses associated with the set of memory cells. In some examples, the write manager 430 may be configured as or otherwise support a means for determining that the set of logical block addresses is within a range of logical block addresses associated with the cloning procedure. In some examples, the memory controller 440 may be configured as or otherwise support a means for writing the data to the set of memory cells in accordance with the first write event or the second write event in response to determining that the set of logical block addresses is within the range of logical block addresses associated with the cloning procedure.

In some examples, the flag manager 450 may be configured as or otherwise support a means for determining a flag value associated with the range of logical block addresses in response to the second indication, the flag value being indicative of whether the first set of one or more first write commands corresponds to the first write event or the second write event. In some examples, the flag manager 450 may be configured as or otherwise support a means for determining that the first set of one or more first write commands corresponds to the first write event or the second write event of the at least two write events associated with the cloning procedure in response to the flag value associated with the range of logical block addresses.

In some examples, the first set of one or more first write commands corresponds to the first write event, and the memory controller 440 may be configured as or otherwise support a means for writing the data in accordance with the first write event. In some examples, the first set of one or more first write commands corresponds to the first write event, and the flag manager 450 may be configured as or otherwise support a means for, in response to writing the data in accordance with the first write event, setting a flag value to indicate a completion of the first write event.

In some examples, the write manager 430 may be configured as or otherwise support a means for receiving a second set of one or more second write commands to write the data to the set of memory cells. In some examples, the flag manager 450 may be configured as or otherwise support a means for determining the flag value associated with the range of logical block addresses in response to receiving the second set of one or more second write commands, where the flag value is indicative of the second set of one or more second write commands corresponding to the second write event. In some examples, the memory controller 440 may be configured as or otherwise support a means for writing the data in accordance with the second write event. In some examples, the second indication includes a context identifier corresponding to a context group associated with the cloning procedure.

In some examples, the first command corresponds to the first write event, and the command manager 425 may be configured as or otherwise support a means for writing the data in accordance with a first cursor associated with the first write event in response to determining that the first command corresponds to the first write event. In some examples, the first command corresponds to the first write event, and the cursor manager 445 may be configured as or otherwise support a means for updating a position of the first cursor in response to writing the data.

In some examples, the write manager 430 may be configured as or otherwise support a means for receiving a second set of one or more second write commands to write the data to the set of memory cells. In some examples, the command manager 425 may be configured as or otherwise support a means for writing the data in accordance with a second cursor associated with the second write event in response to determining that the second set of one or more second write commands corresponds to the second write event. In some examples, the cursor manager 445 may be configured as or otherwise support a means for updating a position of the second cursor in response to writing the data in accordance with the second cursor.

In some examples, the cursor manager 445 may be configured as or otherwise support a means for tracking the position of the second cursor over one or more write operations corresponding to the second write event.

In some examples, the cursor manager 445 may be configured as or otherwise support a means for determining, in response to the position of the second cursor, that a second order associated with writing the data during one or more second write operations of the second write event is different than a first order associated with writing the data during one or more first write operations of the first write event. In some examples, the cursor manager 445 may be configured as or otherwise support a means for outputting an error in response to the second order being different that the first order.

In some examples, the set of memory cells includes a set of QLCs, and the memory controller 440 may be configured as or otherwise support a means for writing the data to the set of QLCs. In some examples, the memory controller 440 may be configured as or otherwise support a means for refraining from writing the data to at least one cache, where the at least one cache includes one or more of SLCs or TLCs.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

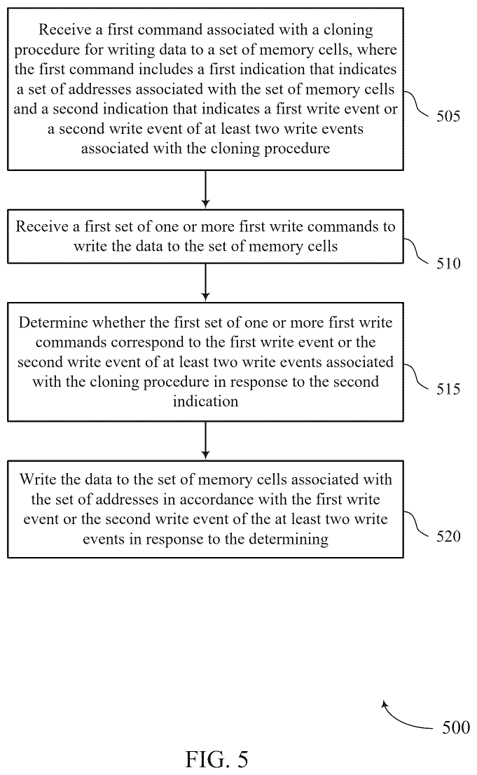

FIG. 5 shows a flowchart illustrating a method 500 that supports implementing a cloning mode in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a first command associated with a cloning procedure for writing data to a set of memory cells, where the first command includes a first indication that indicates a set of addresses associated with the set of memory cells and a second indication that indicates a first write event or a second write event of at least two write events associated with the cloning procedure. In some examples, aspects of the operations of 505 may be performed by a command manager 425 as described with reference to FIG. 4.

At 510, the method may include receiving a first set of one or more first write commands to write the data to the set of memory cells. In some examples, aspects of the operations of 510 may be performed by a write manager 430 as described with reference to FIG. 4.

At 515, the method may include determining whether the first set of one or more first write commands correspond to the first write event or the second write event of the at least two write events associated with the cloning procedure in response to the second indication. In some examples, aspects of the operations of 515 may be performed by a cloning manager 435 as described with reference to FIG. 4.

At 520, the method may include writing the data to the set of memory cells associated with the set of addresses in accordance with the first write event or the second write event of the at least two write events in response to the determining. In some examples, aspects of the operations of 520 may be performed by a memory controller 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a first command associated with a cloning procedure for writing data to a set of memory cells, where the first command includes a first indication that indicates a set of addresses associated with the set of memory cells and a second indication that indicates a first write event or a second write event of at least two write events associated with the cloning procedure; receiving a first set of one or more first write commands to write the data to the set of memory cells; determining whether the first set of one or more first write commands correspond to the first write event or the second write event of the at least two write events associated with the cloning procedure in response to the second indication; and writing the data to the set of memory cells associated with the set of addresses in accordance with the first write event or the second write event of the at least two write events in response to the determining.

Aspect 2: The method, apparatus, or non-transitory computer-readable medium of aspect 1, where the first set of one or more first write commands corresponds to the first write event and the method, apparatuses, and non-transitory computer-readable medium further includes operations, features, circuitry, logic, means, or instructions, or any combination thereof for receiving a second command associated with the cloning procedure, where the second command includes a third indication that indicates the set of addresses and a fourth indication that indicates that a second set of one or more second write commands for writing the data corresponds to the second write event of the at least two write events; receiving the second set of one or more second write commands to write the data to the set of memory cells; determining that the second set of one or more second write commands corresponds to the second write event in response to the fourth indication; and writing the data to the set of memory cells associated with the set of addresses in accordance with the second write event.

Aspect 3: The method, apparatus, or non-transitory computer-readable medium of any of aspects 1 through 2, further including operations, features, circuitry, logic, means, or instructions, or any combination thereof for identifying a set of logical block addresses in response to one or more of the first indication or the second indication, where the set of logical block addresses correspond to the set of addresses associated with the set of memory cells; determining that the set of logical block addresses is within a range of logical block addresses associated with the cloning procedure; and where writing the data to the set of memory cells in accordance with the first write event or the second write event is in response to determining that the set of logical block addresses is within the range of logical block addresses associated with the cloning procedure.

Aspect 4: The method, apparatus, or non-transitory computer-readable medium of aspect 3, further including operations, features, circuitry, logic, means, or instructions, or any combination thereof for determining a flag value associated with the range of logical block addresses in response to the second indication, the flag value being indicative of whether the first set of one or more first write commands corresponds to the first write event or the second write event and where determining that the first set of one or more first write commands corresponds to the first write event or the second write event of the at least two write events associated with the cloning procedure is in response to the flag value associated with the range of logical block addresses.

Aspect 5: The method, apparatus, or non-transitory computer-readable medium of any of aspects 3 through 4, where the first set of one or more first write commands corresponds to the first write event and the method, apparatuses, and non-transitory computer-readable medium further includes operations, features, circuitry, logic, means, or instructions, or any combination thereof for writing the data in accordance with the first write event and in response to writing the data in accordance with the first write event, setting a flag value to indicate a completion of the first write event.

Aspect 6: The method, apparatus, or non-transitory computer-readable medium of aspect 5, further including operations, features, circuitry, logic, means, or instructions, or any combination thereof for receiving a second set of one or more second write commands to write the data to the set of memory cells; determining the flag value associated with the range of logical block addresses in response to receiving the second set of one or more second write commands, where the flag value is indicative of the second set of one or more second write commands corresponding to the second write event; and writing the data in accordance with the second write event.

Aspect 7: The method, apparatus, or non-transitory computer-readable medium of any of aspects 1 through 6, where the second indication includes a context identifier corresponding to a context group associated with the cloning procedure.

Aspect 8: The method, apparatus, or non-transitory computer-readable medium of any of aspects 1 through 7, where the first command corresponds to the first write event and the method, apparatuses, and non-transitory computer-readable medium further includes operations, features, circuitry, logic, means, or instructions, or any combination thereof for writing the data in accordance with a first cursor associated with the first write event in response to determining that the first command corresponds to the first write event and updating a position of the first cursor in response to writing the data.

Aspect 9: The method, apparatus, or non-transitory computer-readable medium of aspect 8, further including operations, features, circuitry, logic, means, or instructions, or any combination thereof for receiving a second set of one or more second write commands to write the data to the set of memory cells; writing the data in accordance with a second cursor associated with the second write event in response to determining that the second set of one or more second write commands corresponds to the second write event; and updating a position of the second cursor in response to writing the data in accordance with the second cursor.

Aspect 10: The method, apparatus, or non-transitory computer-readable medium of aspect 9, further including operations, features, circuitry, logic, means, or instructions, or any combination thereof for tracking the position of the second cursor over one or more write operations corresponding to the second write event.

Aspect 11: The method, apparatus, or non-transitory computer-readable medium of aspect 10, further including operations, features, circuitry, logic, means, or instructions, or any combination thereof for determining, in response to the position of the second cursor, that a second order associated with writing the data during one or more second write operations of the second write event is different than a first order associated with writing the data during one or more first write operations of the first write event and outputting an error in response to the second order being different that the first order.

Aspect 12: The method, apparatus, or non-transitory computer-readable medium of any of aspects 1 through 11, where the set of memory cells includes a set of QLCs and the method, apparatuses, and non-transitory computer-readable medium further includes operations, features, circuitry, logic, means, or instructions, or any combination thereof for writing the data to the set of QLCs and refraining from writing the data to at least one cache, where the at least one cache includes one or more one or more of SLCs or TLCs.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a first command associated with a cloning procedure for writing data to a set of memory cells of the one or more memory devices, wherein the first command comprises a first indication that indicates a set of addresses associated with the set of memory cells and a second indication that indicates a first write event or a second write event of at least two write events associated with the cloning procedure;
receive a first set of one or more first write commands to write the data to the set of memory cells;
determine whether the first set of one or more first write commands correspond to the first write event or the second write event of the at least two write events associated with the cloning procedure in response to the second indication; and
write the data to the set of memory cells associated with the set of addresses in accordance with the first write event or the second write event of the at least two write events in response to the determining.

2. The memory system of claim 1, wherein the first set of one or more first write commands corresponds to the first write event, and the processing circuitry is further configured to cause the memory system to:
receive a second command associated with the cloning procedure, wherein the second command comprises a third indication that indicates the set of addresses and a fourth indication that indicates that a second set of one or more second write commands for writing the data corresponds to the second write event of the at least two write events;
receive the second set of one or more second write commands to write the data to the set of memory cells;
determine that the second set of one or more second write commands corresponds to the second write event in response to the fourth indication; and
write the data to the set of memory cells associated with the set of addresses in accordance with the second write event.

3. The memory system of claim 1, wherein the processing circuitry is further configured to cause the memory system to:
identify a set of logical block addresses in response to one or more of the first indication or the second indication, wherein the set of logical block addresses correspond to the set of addresses associated with the set of memory cells; and
determine that the set of logical block addresses is within a range of logical block addresses associated with the cloning procedure,
wherein to write the data to the set of memory cells in accordance with the first write event or the second write event is in response to determining that the set of logical block addresses is within the range of logical block addresses associated with the cloning procedure.

4. The memory system of claim 3, wherein the processing circuitry is further configured to cause the memory system to:
determine a flag value associated with the range of logical block addresses in response to the second indication, the flag value being indicative of whether the first set of one or more first write commands corresponds to the first write event or the second write event,
wherein to determine that the first set of one or more first write commands corresponds to the first write event or the second write event of the at least two write events associated with the cloning procedure is in response to the flag value associated with the range of logical block addresses.

5. The memory system of claim 3, wherein the first set of one or more first write commands corresponds to the first write event, and the processing circuitry is further configured to cause the memory system to:
write the data in accordance with the first write event; and
in response to writing the data in accordance with the first write event, set a flag value to indicate a completion of the first write event.

6. The memory system of claim 5, wherein the processing circuitry is further configured to cause the memory system to:
receive a second set of one or more second write commands to write the data to the set of memory cells;
determine the flag value associated with the range of logical block addresses in response to receiving the second set of one or more second write commands, wherein the flag value is indicative of the second set of one or more second write commands corresponding to the second write event; and
write the data in accordance with the second write event.

7. The memory system of claim 1, wherein the second indication comprises a context identifier corresponding to a context group associated with the cloning procedure.

8. The memory system of claim 1, wherein the first command corresponds to the first write event, and the processing circuitry is further configured to cause the memory system to:
write the data in accordance with a first cursor associated with the first write event in response to determining that the first command corresponds to the first write event; and
update a position of the first cursor in response to writing the data.

9. The memory system of claim 8, wherein the processing circuitry is further configured to cause the memory system to:
receive a second set of one or more second write commands to write the data to the set of memory cells;
write the data in accordance with a second cursor associated with the second write event in response to determining that the second set of one or more second write commands corresponds to the second write event; and
update a position of the second cursor in response to writing the data in accordance with the second cursor.

10. The memory system of claim 9, wherein the processing circuitry is further configured to cause the memory system to:
track the position of the second cursor over one or more write operations corresponding to the second write event.

11. The memory system of claim 10, wherein the processing circuitry is further configured to cause the memory system to:
determine, in response to the position of the second cursor, that a second order associated with writing the data during one or more second write operations of the second write event is different than a first order associated with writing the data during one or more first write operations of the first write event; and
output an error in response to the second order being different that the first order.

12. The memory system of claim 1, wherein the set of memory cells comprises a set of quad-level cells (QLCs), and the processing circuitry is further configured to cause the memory system to:
write the data to the set of QLCs; and
refrain from writing the data to at least one cache, wherein the at least one cache comprises one or more of single level cells (SLCs) or triple-level cells (TLCs).

13. A non-transitory computer-readable medium storing code, the code comprising instructions executable by one or more processors to:
receive a first command associated with a cloning procedure for writing data to a set of memory cells, wherein the first command comprises a first indication that indicates a set of addresses associated with the set of memory cells and a second indication that indicates a first write event or a second write event of at least two write events associated with the cloning procedure;
receive a first set of one or more first write commands to write the data to the set of memory cells;
determine whether the first set of one or more first write commands correspond to the first write event or the second write event of the at least two write events associated with the cloning procedure in response to the second indication; and
write the data to the set of memory cells associated with the set of addresses in accordance with the first write event or the second write event of the at least two write events in response to the determining.

14. The non-transitory computer-readable medium of claim 13, wherein the first set of one or more first write commands corresponds to the first write event, and the instructions are further executable by the one or more processors to:
receive a second command associated with the cloning procedure, wherein the second command comprises a third indication that indicates the set of addresses and a fourth indication that indicates that a second set of one or more second write commands for writing the data corresponds to the second write event of the at least two write events;
receive the second set of one or more second write commands to write the data to the set of memory cells;
determine that the second set of one or more second write commands corresponds to the second write event in response to the fourth indication; and
write the data to the set of memory cells associated with the set of addresses in accordance with the second write event.

15. The non-transitory computer-readable medium of claim 13, wherein the instructions are further executable by the one or more processors to:
identify a set of logical block addresses in response to one or more of the first indication or the second indication, wherein the set of logical block addresses correspond to the set of addresses associated with the set of memory cells; and
determine that the set of logical block addresses is within a range of logical block addresses associated with the cloning procedure,
wherein to write the data to the set of memory cells in accordance with the first write event or the second write event is in response to determining that the set of logical block addresses is within the range of logical block addresses associated with the cloning procedure.

16. The non-transitory computer-readable medium of claim 15, wherein the instructions are further executable by the one or more processors to:
determine a flag value associated with the range of logical block addresses in response to the second indication, the flag value being indicative of whether the first set of one or more first write commands corresponds to the first write event or the second write event,
wherein to determine that the first set of one or more first write commands corresponds to the first write event or the second write event of the at least two write events associated with the cloning procedure is in response to the flag value associated with the range of logical block addresses.

17. The non-transitory computer-readable medium of claim 15, wherein the first set of one or more first write commands corresponds to the first write event, and the instructions are further executable by the one or more processors to:
write the data in accordance with the first write event; and
in response to write the data in accordance with the first write event, set a flag value to indicate a completion of the first write event.

18. The non-transitory computer-readable medium of claim 17, wherein the instructions are further executable by the one or more processors to:
receive a second set of one or more second write commands to write the data to the set of memory cells;
determine the flag value associated with the range of logical block addresses in response to receiving the second set of one or more second write commands, wherein the flag value is indicative of the second set of one or more second write commands corresponding to the second write event; and
write the data in accordance with the second write event.

19. The non-transitory computer-readable medium of claim 13, wherein the second indication comprises a context identifier corresponding to a context group associated with the cloning procedure.

20. A method, comprising:
receiving a first command associated with a cloning procedure for writing data to a set of memory cells, wherein the first command comprises a first indication that indicates a set of addresses associated with the set of memory cells and a second indication that indicates a first write event or a second write event of at least two write events associated with the cloning procedure;
receiving a first set of one or more first write commands to write the data to the set of memory cells;
determining whether the first set of one or more first write commands correspond to the first write event or the second write event of the at least two write events associated with the cloning procedure in response to the second indication; and
writing the data to the set of memory cells associated with the set of addresses in accordance with the first write event or the second write event of the at least two write events in response to the determining.
